(19) United States
(12) Patent Application Publication
(10) Pub. No.: US 2015/0030231 A1
(43) Pub. Date: Jan. 29, 2015

(54) Method for Data Segmentation using Laplacian Graphs

(71) Applicant: Mitsubishi Electric Research Laboratories, Inc., Cambridge, MA (US)

(72) Inventors: Fatih Porikli, Watertown, MA (US); Feng Li, Quincy, MA (US)

(73) Assignee: Mitsubishi Electric Research Laboratories, Inc., Cambridge, MA (US)

(21) Appl. No.: 13/948,397

(22) Filed: Jul. 23, 2013

(51) Int. Cl. G06T 7/00

(52) U.S. Cl. CPC G06T 7/0093
USPC 382/154; 382/173

(57) ABSTRACT

A method segments n-dimensional by first determining prior information from the data. A fidelity term is determined from the prior information, and the data are represented as a graph. A graph Laplacian is determined from the graph from the graph, and a Laplacian spectrum constraint is determined from the graph Laplacian. Then, an objective function is minimized according to the fidelity term and the Laplacian spectrum constraint to identify a segment of target points in the data.

### FIELD OF THE INVENTION

The invention relates generally to data segmentation, and more particularly to segmenting pixels in images.

### BACKGROUND OF THE INVENTION

Data segmentation is used extensively in many computer applications. In computer vision, the segmentation operates on 2D images of pixels or 3D volumetric data of voxels. For it segmentation x, a spectral segmentation method with multi-scale graph decomposition minimizes x^{T}Ax/(x^{T}D_{g}x), where A is an affinity matrix, D_{g} is a diagonal matrix, and T is a transform operator. Some methods treat image segmentation as a graph partitioning problem where a normalized cut criterion measures a dissimilarity between different group of pixels and a similarity within the groups. Random walk is a seeded segmentation method that determines the probability that a walk starting at each unlabeled pixel y(i, j) reaches prelabeled pixels by solving a closed form equation using a graph Laplacian where weights A(i,j)=exp(yᵢ,yⱼ)²/θ, and θ is a global scaling factor, see e.g., U.S. Pat. Nos. 7,286,127, 7,692,664.

A matting Laplacian matrix can be derived from multiple matte equations. In comparison with the random walk and normalized cuts, that method adapts a correlation measure instead of an exponent of color distance, and a local scaling, instead of global, scaling, and formulate a least square solution with constraints from user input. Local scaling leads to better clustering, especially when the data include multiple scales and the clusters are placed within a cluttered background.

A structure of eigenvectors can be analyzed to infer automatically the number of groups, instead of increases in eigenvalue magnitudes. Another method uses a dark channel prior to model the thickness of haze and apply the matting Laplacian to refine a transmission map.

### SUMMARY OF THE INVENTION

The embodiments of the invention provide a method for segmenting n-dimensional data, for example, two-dimensional (2D) data that represent pixels in one or more image acquired by a sensor. The data can also be 3D, such as volumetric data obtained from medical, or geological scans. Higher dimensional data can also be segmented.

The method identifies target data, e.g., pixels or voxels of interest that are associated with ‘foreground’ regions in the images. The method uses a graph Laplacian spectrum constraint to incorporate point-wise scalar prior vectors for the binary segmentation. Prior vectors align a rough, incomplete, or noisy initial segmentation, e.g., a foreground mask, a saliency map, a defocus field, or an object detection window, to a preferred structures in the n-dimensional data, e.g., to object boundaries or gradients. The segmentation uses an objective function.

Alternative embodiments include projection to a null-space, a convex function with l₂-norm, a convex function with l₁-norm, a sparse decomposition, or a robust function, known as a Welsch function in the art of robust statistics.

Specifically, a method segments n-dimensional by first determining prior information from the data. A fidelity term is determined from the prior information, and the data are represented as a graph.

A graph Laplacian is determined from the graph from the graph, and a Laplacian spectrum constraint is determined from the graph Laplacian. Then, an objective function is minimized according to the fidelity term and the Laplacian spectrum constraint to identify a segment of target points in the data.

### BRIEF DESCRIPTION OF THE DRAWINGS

FIG. 1 is a block diagram of a method for segmenting ii-dimensional data according to embodiments of the invention;

FIG. 2 is a block diagram of alternative objective functions according to embodiments of the invention;

FIG. 3 is a schematic of the method for segmenting an image according to embodiments of the invention; and

FIG. 4 is a block diagram of pseudocode of a robust function according to embodiments of the invention.

### DETAILED DESCRIPTION OF THE PREFERRED EMBODIMENTS

Segmentation Method

The embodiments of our invention provide a method for segmenting n-dimensional data. The data can be acquired by a sensor or constructed by some other means. In an example application, a binary segmentation locates areas of interest in one or more images by partitioning a foreground region and detecting an object surface. In one embodiment, the object is a human organ, and the images provide volumetric data, e.g., as acquired by medical imaging.

The method uses a graph Laplacian spectrum constraint to impose structure and point-wise constraints during the segmentation. As known in the art and used herein, the Laplace operator is the second order differential operator defined as the divergence of the gradient in a Euclidean space. It is understood that the method can segment any n-dimensional data.

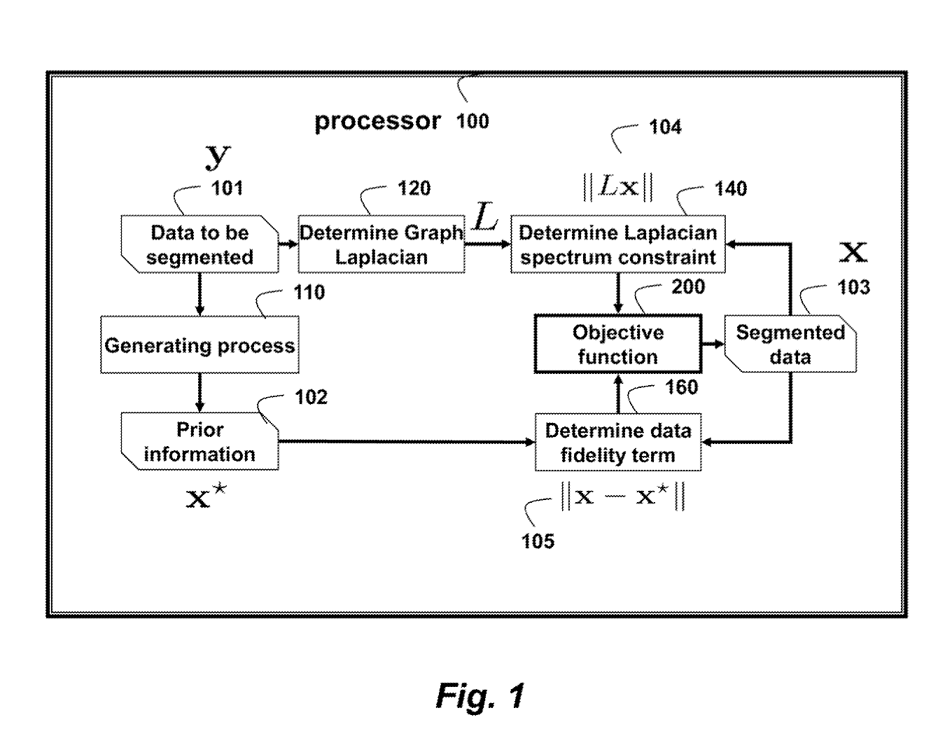

As show in FIG. 1 for an example application, input to the method is the n-dimensional data y 101, e.g., an image of pixels. Output is a segment x 103 of data, e.g., target points or pixels of interest. A process 110 generates prior information x* 102 to guide the iterative segmentation. The prior information, as described in detail below, can include likelihood weights or a confidence map indicating data point as being associated with a foreground region, noisy and incomplete foreground masks in change detection, noisy saliency results, defocus scores, detected object ‘coordinates’ or ‘ellipse/box’ region. The prior information is used to determine 160 a data fidelity term ∥x−x*∥ 105.

We represent the n-dimensional data y with a graph G, and determine 120 a graph Laplacian L, which is used to determine 140 a Laplacian spectrum constraint ∥Lx∥ 104. The fidelity term and the spectrum constraint are used to optimize an objective function 200 that produces the segment at x 103 when the objective function is optimized.

We can use our method to partition the data into multiple segments. This can be done iteratively, e.g., by removing the identified segment from the data after each segmentation step and repeating the segmentation on the remaining part of the data to obtain a non-overlapping set of partitions, or by changing and updating the prior to obtain multiple, possibly overlapping segments.

For a temporal data, for instance a given video sequence, we can apply our segmentation method to track target objects. In this case, we set the prior information is the object region in the previous frame. We compute the graph Laplacian from the current frame and segment the current frame. The identified segment in the current frame corresponds to the object region in the current frame. This process is repeated by using the previous region as a prior to current frame to track and segment target objects.

Objective Functions

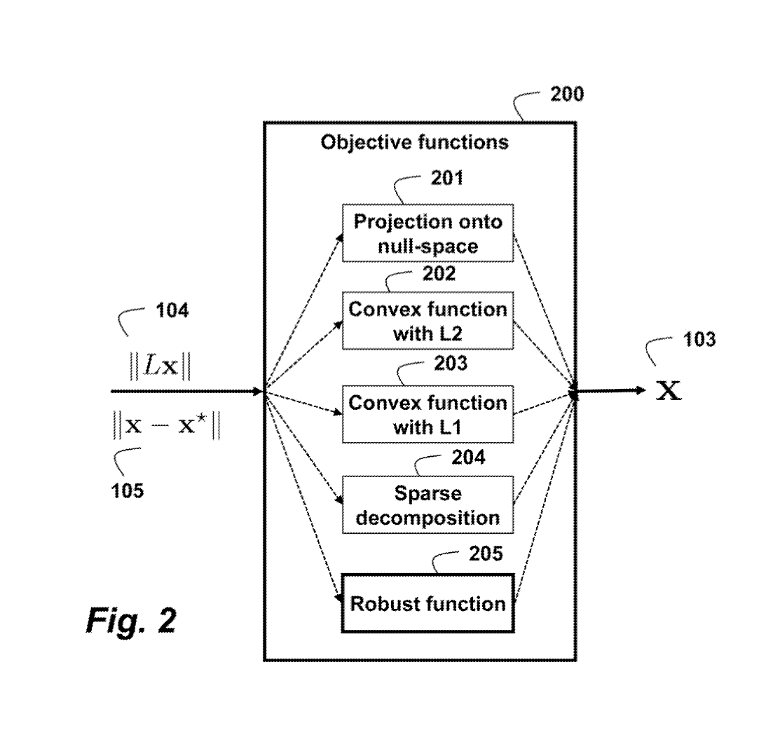

As shown in FIG. 2, alternative embodiments for the objective function 200 include projection to a null-space 201, a convex function with l₂-norm 202, a convex function with l₁-norm 203, a sparse decomposition 204, and a robust function 205. The robust function generates better results for several preferred applications on two-dimensional (2D) images. The method can be extended to any graph bipartitioning problems in higher dimensional spaces, such as clustering vector data.

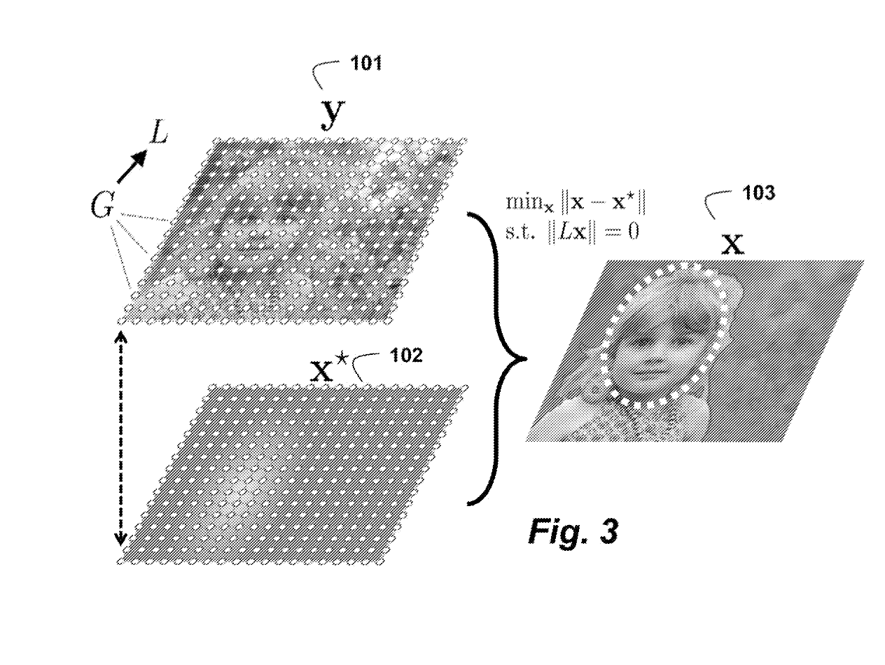

FIG. 3 shows the segmentation schematically for an image. The structure in the n-dimensional data (image) y is imposed on the segment x. The prior information x* guides the segmentation process. For example, y can be the input image in vector form, x* can be the likelihood weights or the confidence map indicating an image pixel belonging to a foreground regions, and x is the set of (foreground) pixels to be selected by the segmentation. The term foreground is used generally here, as conventional image segmentation frameworks, to mean any set of target pixels of interest to be segmented.

Our method can use different priors. In addition to the ones above, we use a set of labeled pixels selected by a user operator or by another process as the prior information for interactive image and data segmentation. Such labeled pixels can be obtained as annotations from image labeling methods, multiple users, or a feedback control process.

The method and other procedures described herein can be performed in a processor 100 connected to memory and input/output interfaces as known in the art.

Graph Laplacian

The image y is represented with the graph G. This structure imposing graph is constructed by assigning each point (pixel) in y as a vertex and connecting the vertices via weighted edges within N-connectivity, in other words, each vertex is an image pixel and each edge is the affinity value of two pixels, in a patch [symbol] containing N+1 pixels, and a center pixel of the patch. Therefore, the graph G is a sparse and is almost an N regular graph, except on the boundary vertices, which have less than N neighbors. For a 2D image y of size \sqrt{n}×\sqrt{n}, G has n vertices. Different connectivity and weighting schemes can generate different weighted graphs. It should be understood that the graph can be constructed, for higher dimensional data.

The graph Laplacian L, a positive-semidefinite matrix, representation of the graph G, is defined as L=D_{g}−A, where A is the adjacency matrix of G, and G_{g}, is a diagonal matrix D_{g}(i,i)=ΣⱼA(i,j) as

$$L ( i , j ) = \{ \begin{matrix}deg ( i ) & if i = j \\ - 1 & if \{ i , j \} ∈ N \\ 0 & if \{ i , j \} ∉ N\end{matrix} . \qquad ( 1 )$$

Instead of the degree matrix, many applications use a weighted adjacency, i.e., A(i,j)=ω(i,j), where ω can be a function measuring the affinity of two vertices.

Various forms of the graph Laplacian matrix have been adopted for different applications, such as image segmentation by normalized cuts, image segmentation by random walks, data classification, and matte estimation.

Laplacian matrix can be derived from a matting equation and the matrix can use a local scaling scheme for each vertex to allow self-tuning of the vertex-to-vertex similarity according to local statistics. Instead of determining an intensity distance or a Mahalanobis distance between two pixels, the matting Laplacian determines a relaxed correlation measurement of different pixels within a local 3×3 window, which in essence corresponds to a 24-neighborhood connectivity when the matting equations are analyzed. The random walk segmentation often defines L for a 4- or 8-neighborhood, and uses an exponential function for the weights ω.

Laplacian Spectrum Constraint

To incorporate the prior information, we determine the graph Laplacian matrix L from G. In other words, the Laplacian matrix L regularizes our under-constrained optimization formulation using the structure inherent in y. This enables us to define the binary segmentation problem as a least-squares constrained optimization

$${min}_{x} {‖ x - {x}^{*} ‖}^{2} , \\ s . t . Lx = 0. \qquad ( 2 )$$

The constraint Lx=0 is the Laplacian spectrum constraint. This is a generalization of the conventional approaches and does not require a specific numerical solver as the matting Laplacian.

For the Laplacian matrix L, we have the following property. The multiplicity of λ=0 as an eigenvalue of L is equal to the number of connected components in the graph G. The vector e=[1, . . . , 1]^{T} is an eigenvector for L with eigenvalue 0:

$${\sum }_{j = 1}^{n} L ( i , j ) {e}_{j} - {\sum }_{j = 1}^{n} L ( i , j ) = deg ( i ) - {\sum }_{i , j ∈ r}^{ } A ( i , j ) = 0. \qquad ( 3 )$$

if G₁, . . . , G_{c} are the components of G, then L partitions into block matrices L₁, . . . , L_{c}. Let k denote the multiplicity of 0. Each Lᵢ has an eigenvector zᵢ with 0 eigenvalue, so k≧c. Any eigenvector v=[v₁, . . . , vₙ]^{T} for 0 lies in span of z₁, . . . , z_{c}. Let vᵢ>0 be the largest entry of V. This shows that Σⱼ₌₁ⁿ(vᵢ−vⱼ)=0, which implies that vᵢ=vⱼ if i and j are in the same connected component of G.

Here a ‘connected component’ represents a subgraph of G in which any two vertices are connected to each other, and are not connected to any other vertices in a remaining part of the graph. In our image segmentation context, a connected component corresponds to regions having the same label.

The above property indicates that the spectrum of L determines the number of connected components in G. This means that property ensures that the different connected subgraphs are perfectly segmented. For example, let λᵢ be the i^{th} smallest eigenvalue of L, λ₁≦λ₂≦ . . . ≦λₙ.

Then, we have λ₁=0 because Le=0, where e is the above all-1 vector in [symbol] . This can be directly derived from the definition of the Laplacian matrix. Suppose the multiplicity of 0 eigenvalue is k, that is, λ₁= . . . =λₖ=0 and 1≦k=n. Obviously, k is the dimension of L's null-space null(L) and the k smallest eigenvectors corresponding to these 0 eigenvalues comprise a basis of this null-space. An arbitrary linear transformation of these k eigenvectors generates another basis.

We are interested in a specific basis such that each of these k orthogonal vectors has 1 for all the vertices of a component of the graph and 0 for the rest of the vertices, and the sum of these k vectors is v. This ‘ideal’ basis gives us the perfect segmentation x of the input in-dimensional data y. However, due to numerical errors and the limited connectivity of the graph G, one cannot determine k by simply examining the multiplicity of 0 eigenvalue. A better way is to search for a significant change in the magnitude of the eigenvalues starting from λ₁. In practice, the numerical stability of estimating k highly depends on the noise, the data structure, and the construction of G, and thus L.

The graph Laplacian spectrum constraint enforces a given structure in the input data on the prior information as expressed by the data fidelity term ∥x−x*∥². At the same time, the objective function, as described below, achieves accuracy in the presence of outliers. With this constraint, the optimal segment x lies in the null-space of L, that is, x is constant within each connected component of the graph G. In most cases, the objective binary segmentation results, e.g. foreground and background regions, includes several disconnected components. Because the segment x can be represented by a linear combination of the 0 eigenvectors, or the ‘ideal’ basis, the objective function is still able to differentiate the foreground components from the background components. In this way, we can explicitly avoid determining L's nullity k and its basis, while still using the structure in the input data to regularize the data fidelity term.

Objective Function

We describe alternative objective functions to enforce our Laplacian spectrum constraint Lx=0 on the fidelity term ∥x−x*∥². Depending on the norm, several objective functions can be used.

Projection onto Null-Space

Estimating an optimal segment x for the constrained optimization in Eq. (2) can be considered as a search for a vector in the null-space of L, which has a smallest distance to the prior information x*.

Let v₁, . . . , vₖεRⁿ be the k eigenvectors of L corresponding to 0 eigenvalue, and let W=Span (v₁, . . . , vₖ) be the k-dimensional subspace of Rⁿ spanned by these eigenvectors. W is the null-space of L, null(L)=W. Let V=[v₁, . . . , vₖ], the optimal solution can be estimated as

x=Proj_{W}(x*)=Qx*, (4)

where Q is the projection matrix for the subspace W, and Q=V(V^{T}V)⁻¹V^{T}=VV^{T} because vᵢ are unit vectors.

The assumption is that the nullity k of L can be determined accurately, which is not always true. Another problem is that this approach approximates x using Proj_{W} (x*), while a solution that is a linear combination of x* and Proj_{W} (x*) is more favorable due to noise, limited connectivity of graph G, and computational load.

Convex Function with l₂ Norm on Constraint

Instead of solving a constrained optimization in Eq. (2), we can transform it into an unconstrained minimization

$${min}_{x} {‖ x - {x}^{*} ‖}^{2} + β {‖ Lx ‖}^{2} , \qquad ( 5 )$$

with a penalty term β that enforces the structure in y.

Setting the derivative of the objective function Eq. (5) to 0, we obtain a closed form solution:

x=(βL^{T}L+I)⁻¹x*, (6)

where I is an identity matrix. Let P=(βL^{T}L+I)⁻¹, which can be viewed as a modified projection matrix.

We draw the connection between P and the previous Q. Because L is a real symmetric matrix, we can diagonalize it as L=VΛV^{T}, where V is an orthogonal matrix V=[v₁, . . . , vₙ], and Λ is a diagonal matrix constructed from the eigenvalues of L as Λ=diag(λ₁, . . . , λₙ). Therefore, P can be rewritten as

$$\begin{matrix}P = {V ( β {Λ}^{2} + I )}^{- 1} {V}^{T} \\ = {\sum }_{i = 1}^{n} \frac{1}{1 + β {λ}_{i}^{2}} {v}_{i} {v}_{i}^{T} \\ = Q + {\sum }_{i = k + 1}^{n} \frac{1}{1 + β {λ}_{i}^{2}} {v}_{i} {v}_{i}^{T} .\end{matrix} \qquad ( 7 )$$

Eq. (7) indicates that the solution of the penalized least squares in Eq. (5) is the weighted sum of the projection of x* each subspace vᵢvᵢ^{T}. Also, P adds influence of non-zero eigenvectors into the final estimate based on their corresponding eigenvalues and penalty term β. If β→∞, P=Q, this Eq. (5) becomes the constrained least square in Eq. (2).

Convex Function with l₁ Norm on Constraint

Instead of enforcing the Laplacian spectrum constraint in the l₂ norm, we can use the lₗ norm to decrease the influence of the large outliers in the noisy prior. In this case, β is not required to approach to ∞ in order to solve the original constrained minimization.

The objective function can be rewritten as

$${min}_{x} \frac{μ}{2} {‖ x - {x}^{*} ‖}^{2} + {‖ Lx ‖}_{1} ,$$

(8) and solved using an Augmented Lagrangian method that replaces a constrained optimization problem by a series of unconstrained problems and by adding an additional term to unconstrained objective to mimic a Lagrange multiplier. Here, p is a scalar parameter that controls the contribution of the fidelity term with respect to the graph Laplacian spectrum constraint term.

Specifically, we use alternating direction methods in the following iterative framework

$$\{ \begin{matrix}{a}^{t + 1} ← * arg {min}_{x , a} {L}_{A} ( {x}^{t} , a , {c}^{t} ) , \\ {x}^{t + 1} ← * arg {min}_{x , a} {L}_{A} ( x , {a}^{t + 1} , {c}^{t} ) , \\ {c}^{t + 1} ← {c}^{t} - β ( {a}^{t + 1} - {Lx}^{t + 1} ) ,\end{matrix} \qquad ( 9 )$$

where a is an auxiliary vector, β is a penalty term, and L_{A}(x,a,c^{l}) is the augmented Lagrangian function of Eq. (8) defined as

$${L}_{A} ( x , a , c ) = \frac{μ}{2} {‖ x - {x}^{*} ‖}^{2} + {‖ a ‖}_{1} - {c}^{T} ( a - Lx ) + \frac{β}{2} {‖ a - Lx ‖}^{2} , \qquad ( 10 )$$

where c is the Lagrangian parameter vector that has the same length as a and x. For each suboptimization, we can solve them directly by

$$\begin{matrix}{a}^{t + 1} = sgn ( {Lx}^{t} + \frac{1}{β} {c}^{t} ) • max \{ ‖ {Lx}^{t} + \frac{1}{β} {c}^{t} ‖ - \frac{1}{β} , 0 \} \\ and & ( 11 ) \\ ( {L}^{T} L + \frac{μ}{β} I ) {x}^{t + 1} = {L}^{T} ( {a}^{t + 1} - \frac{1}{β} {c}^{t} ) + \frac{μ}{β} {x}^{*} , & ( 12 )\end{matrix}$$

where ∘ and sgn represent the point-wise product and the signum function, respectively.

The general total variation problem is solved by designing an auxiliary variable, which transfers the total variation ∇x out of the regularization term and the original problem into a constrained optimization. Then, the augmented Lagrangian method is applied to solve this transformed constrained optimization. In our case, we could solve Eq. (2) directly using the augmented Lagrangian method without enforcing the constraint in the l₁ form. The results are very similar to the projection of x* onto the null(L).

The l₁ norm is effective when the error is in the form of the impulsive noise. However, the regularization error is often continuous and has large values in arbitrary regions of the image.

Sparse Decomposition

As known in the art of compressed sensing (CS), also known as sparse sampling, sparsity refers to data or signals that are mostly null, and only has a very small number of non-zero values. We use this sparsity concept to determine solutions for our underdetermined linear systems.

Another approach to apply the Laplacian spectrum constraint is to analyze its error map, i.e., xₑᵣᵣ=Lx. An optimal solution of Eq. (2) has the property that most items of xₑᵣᵣ have 0 value and only a few have large errors, which means we can rewrite Eq. (2) in terms of error sparsity as

$${min}_{α} {‖ {x}^{*} - D α ‖}^{2} + β {‖ α ‖}_{1} , \qquad ( 13 )$$

where α=Lx and a decomposition dictionary D is defined as D=L⁺, because x=L⁺α and L⁺ is a pseudoinverse of L. In this case, we have to determine the explicit inverse of the Laplacian matrix L^{T}L, which is numerically inaccurate and computationally impractical because L is a large sparse matrix. Another problem of this approach is that L⁺ is no longer a sparse matrix, which requires an extremely large memory space for processing and storage.

Instead of determining L⁺ as the decomposition dictionary D, we can construct it directly from the Laplacian spectrum constraint. In the ideal case, the optimal x can be represented by a linear combination of L's 0 eigenvectors, that is x=Σᵢ₌₁^{k}αᵢvᵢ, where vᵢ is the eigenvector corresponding to the i^{th} smallest eigenvalue vᵢ of L.

This property can be easily extended to x=Dα in matrix form, where

D=[v₁, . . . , v_{k′}],k′?k. (14)

As long as is much larger than k, we have a sparse vector a, which can be efficiently solved.

The equation x=Dα indicates that the final estimate x is actually an approximated projection of x* on the null-space of L because we limit the number of nonzero values in α and vₘ (m>k) may also contribute to the final estimate x. Compared with the approach, which directly projects x* onto L's null space, this approach is more accurate and can solve Eq. (2) without explicitly determining the nullity k of L.

Robust Function

Because the residual δ=|x−x*| has many spatially continuous large outliers and the least square data fidelity team weights each sample with a quadratic norm, the final estimation of Eq. (5) can be distorted severely. Depending on its quality, the prior information x* can contain incomplete and inaccurate indicators, for instance strong responses across the segment boundaries. This can cause mislabeling.

A better option is to weight large outliers less and use the structure information from the Laplacian spectrum constraint to recover x. Therefore, we adapt principles from robust statistics. As known in the art, robust statistics are typically applied to data drawn from a wide range of probability distributions, and especially for distributions that are not normally distributed. As an advantage, robust statistics are not unduly affected by outliers, see e.g., U.S. Pat. Nos. 8,340,4168, 8,194,097, and 8,078,002.

We use a robust function to replace the least square cost as

$${min}_{x} ρ ( x - {x}^{*} ) + β {‖ Lx ‖}^{2} , \qquad ( 15 )$$

where ρ is the robust function, e.g., a Huber function, a Cauchy function, l₁, or other M-estimators. We prefer the Huber function because it is parabolic in the vicinity of 0, and increases linearly when δ is large. Thus, the effects of large outliers can be eliminated significantly. We define the weight function w=[w₁, . . . , wₙ]^{T} at each pixel associated with the Huber function as

$${w}_{i} = \{ \begin{matrix}1 & if {δ}_{i} < ɛ \\ ɛ \text{/} {δ}_{i} & if {δ}_{i} \geq ɛ\end{matrix} . \qquad ( 16 )$$

When written in matrix form, we use a diagonal weighting matrix W=diag(w₁, . . . , wₙ) to represent the Huber weight function. Therefore, the data fidelity term can be simplified as ρ(x−x*)=∥W(x−x*)∥². As a result, Eq. (15) can be solved efficiently in an iterative least square approach. At each iteration, the x is updated as

x=(βL^{T}L+W)⁻¹Wx*. (17)

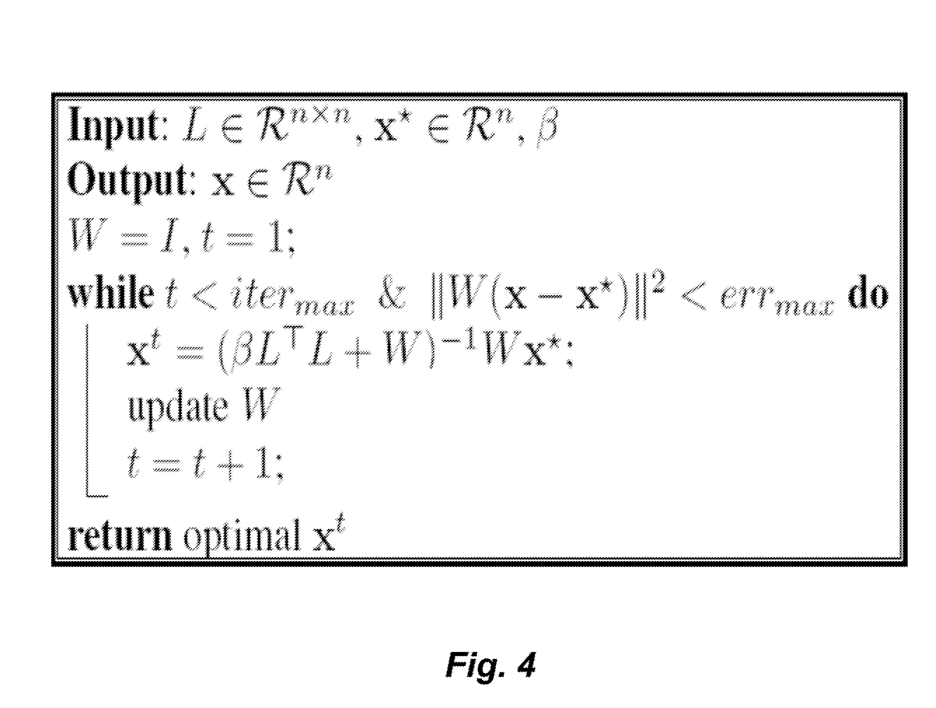

If we set W=I, then Eq. (17) is the same as Eq. (6). The pseudocode for the robust function (15) is shown in FIG. 4. The variables used in the pseudocode are described above.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for segmenting data, wherein the data are n-dimensional, comprising the steps of:
determining prior information from the data;
determining a fidelity term from the prior information;
representing the data as a graph;
determining a graph Laplacian from the graph;
determining a Laplacian spectrum constraint from the graph Laplacian; and
minimizing an objective function according to the fidelity term and the Laplacian spectrum constraint to identify a segment of target points in the data, wherein the steps are performed in a processor.

2. The method of claim 1, wherein the data represents an image of pixels, and the target points are pixels of interest.

3. The method of claim 1, wherein the data represents a volume of voxels, and the target points are voxels of interest.

4. The method claim 1, wherein the Objective function projects the data to a null-space.

5. The method of claim 1, wherein the objective function is a convex function with an l₁-norm.

6. The method of claim 1, wherein the objective ruction is a convex function an l₂-norm.

7. The method of claim wherein the objective function uses a sparse decomposition.

8. The method of claim 1, where the objective function uses robust statistics, and a robust function.

9. The method of claim 1, wherein the graph Laplacian spectrum constraint impose a structure and point-wise constraints during the segmenting.

10. The method of claim 1, wherein the segment is x and the prior information is x*, and the fidelity term is ∥x−x*∥.

11. The method of claim 1, wherein is the Laplacian, spectrum constraint has a property that a multiplicity of λ=0 as an eigenvalue of the graph Laplacian is equal to a number of connected components in the graph G, and the connected component represents a subgraph of G in which any two vertices are connected to each other, and not connected to any other vertices in a remaining part of the graph to segment the subgraphs.

12. The method of claim 4, wherein the projecting searches for a vector in the null-space of the graph Laplacian that has a smallest closest distance to the prior information.

13. The method of claim 5, wherein the convex function is
$${min}_{x} {‖ x - {x}^{*} ‖}^{2} + β {‖ Lx ‖}^{2} ,$$
wherein x is the segment, x* the prior information, β is a penalty term that enforces a structure in the data on the segment, and L is the graph Laplacian.

14. The method of claim 6, wherein the convex function is
$${min}_{x} \frac{μ}{2} {‖ x - {x}^{*} ‖}^{2} + {‖ Lx ‖}_{1} ,$$
wherein μ is a scalar parameter, x is the segment, x* the prior information, β is a penalty term that enforces a structure in the data on the segment, and L is the graph Laplacian.

15. The method of claim 7, wherein the objective function is
$${min}_{α} ‖ {x}^{*} - D α ‖ 2 + β {‖ α ‖}_{1} ,$$
wherein x* the prior information, α=Lx wherein L is the graph Laplacian and x is the segment, and D is a decomposition dictionary D defined as D=L⁺ where L⁺ is a pseudoinverse of L.

16. The method of claim 8, wherein the objective function is
$${min}_{x} ρ ( x - {x}^{*} ) + β {‖ Lx ‖}^{2} , \qquad ( 15 )$$
wherein x is the segment, x* the prior information, β is a penalty term that enforces a structure in the data on the segment, L is the graph Laplacian, and ρ is a Huber function.

17. The method of claim 1, wherein the prior information is selected from a group consisting, of likelihood weights, a confidence map indicating the data associated with a foreground region, noisy and incomplete foreground masks in change detection, noisy saliency results, defocus scores, detected object coordinates and combinations thereof.

18. The method of claim 1, wherein the prior information is given as a set of labeled pixels selected by a user operator.

19. The method of claim 1, wherein the segment is removed from the n-dimensional data and the segmenting is are repeated to partition the data into multiple segments.

20. The method of claim 1, wherein the prior information is an object region in previous data and the data are from a temporal data sequence, and the segment in the current data is the object region in the current data for tracking an object in temporal data sequence.
